(19) United States
(12) Patent Application Publication
(10) Pub. No.: US 2022/0004224 A1
(43) Pub. Date: Jan. 6, 2022

(54) VIEWING ANGLE DIFFUSION PLATE AND DISPLAY PANEL

(71) Applicant: TCL CHINA STAR OPTOELECTRONICS TECHNOLOGY CO., LTD., Shenzhen, Guangdong (CN)

(72) Inventors: Hu DOU, Shenzhen, Guangdong (CN); Ziping WU, Shenzhen, Guangdong (CN); Gang YU, Shenzhen, Guangdong (CN)

(21) Appl. No.: 16/975,446

(22) PCT Filed: Jul. 10, 2020
(86) PCT No.: PCT/CN2020/101231

§ 371 Date: Aug. 25, 2020

(30) Foreign Application Priority Data
Jul. 2, 2020 (CN) 202010628702.X

(51) Int. Cl. G06F 1/16; G02B 5/02

(52) U.S. Cl. CPC G06F 1/1609; G02B 5/0278; G02B 5/0215

(57) ABSTRACT

The present application discloses the present application discloses a viewing angle diffusion plate and a display panel. The viewing angle diffusion plate includes a substrate and a plurality of refractive protrusions provided on a surface of the substrate, wherein each of the refractive protrusions includes a first portion and a second portion, the first portion includes a first side surface forming a first angle with the surface of the substrate, the second portion includes a second side surface disposed close to the first side surface and forming a second angle with the surface of the substrate.

### BACKGROUND OF INVENTION

### Field of Invention

The present application relates to a field of display technology, in particular to a viewing angle diffusion plate and a display panel.

### Description of Prior Art

With the improvement of the resolution of the display panel, the brightness performance of the display panel at a large viewing angle is getting worse. In order to solve this problem, a layer of viewing angle diffusion plate is usually added to the display panel in the industry to modulate light from the positive viewing angle to a large viewing angle of the display panel, thereby increasing the display brightness of the large viewing angle.

However, the existing viewing angle diffusion plate generally has only one modulation angle for a beam of incident light, resulting in a limited ability to modulate the incident light wave. When dealing with a display panel with a relatively concentrated light shape emitted by a light source, a viewing angle diffusion effect of the viewing angle diffusion plate is poor, impacting the customer experience.

In the existing touch display device using a privacy film for anti-peeping, since the privacy film has a certain thickness, installing the privacy film will increase an overall thickness of the touch display device and lower the user experience.

### SUMMARY OF INVENTION

In a first aspect, an embodiment of the present application provides a viewing angle diffusion plate, including a substrate and a plurality of refractive protrusions provided on a surface of the substrate,

wherein each of the refractive protrusions includes a first portion and a second portion, the first portion includes a first side surface forming a first angle with the surface of the substrate, the second portion includes a second side surface disposed close to the first side surface and forming a second angle with the surface of the substrate.

In some embodiments, the first side surface includes a first inclined surface inclined downward in a direction away from an axis of the first portion, and the second side surface includes a second inclined surface inclined downward in a direction away from an axis of the second portion.

In some embodiments, the second portion is located on a side of the first portion away from the substrate.

In some embodiments, the second portion adjoins a side of the first portion.

In some embodiments, a refractive index of the first portion is greater or smaller than a refractive index of the second portion.

In some embodiments, the viewing angle diffusion plate further includes a protective layer covering the refractive protrusions, wherein a refractive index of the protective layer is greater than a refractive index of the refractive protrusions.

In some embodiments, the viewing angle diffusion plate further includes a polarizing film disposed on a side of the substrate away from the refractive protrusions.

In some embodiments, the plurality of the refractive protrusions are arranged at intervals.

In some embodiments, the refractive protrusions are integrally formed with the substrate.

In a second aspect, the present application further provides a display panel, including a display screen body and a viewing angle diffusion plate, wherein the viewing angle diffusion plate is disposed on a light-exiting side of the display screen body, and the viewing angle diffusion plate includes a substrate and a plurality of refractive protrusions provided on a surface of the substrate,

wherein each of the refractive protrusions includes a first portion and a second portion, the first portion includes a first side surface forming a first angle with the surface of the substrate, the second portion includes a second side surface disposed close to the first side surface and forming a second angle with the surface of the substrate.

In some embodiments, the first side surface includes a first inclined surface inclined downward in a direction away from an axis of the first portion, and the second side surface includes a second inclined surface inclined downward in a direction away from an axis of the second portion.

In some embodiments, the second portion is located on a side of the first portion away from the substrate.

In some embodiments, the second portion adjoins a side of the first portion.

In some embodiments, a refractive index of the first portion is greater or smaller than a refractive index of the second portion.

In some embodiments, the display panel further includes a protective layer covering the refractive protrusions, wherein a refractive index of the protective layer is greater than a refractive index of the refractive protrusions.

In some embodiments, the display panel further includes a polarizing film disposed on a side of the substrate away from the refractive protrusions.

In some embodiments, the plurality of the refractive protrusions are arranged at intervals.

In some embodiments, the refractive protrusions are integrally formed with the substrate.

In some embodiments, each of an entire vertical cross section of the first portion and an entire vertical cross section of the second portion has a shape of positive trapezoid.

In some embodiments, the first portion is integrally formed with the second portion.

The first side surface of the first portion of each of the refraction protrusions is not parallel to the second side surface of the second portion. When a light beam emitted by the light source of the display panel is incident into the refraction protrusions, parallel light rays are refracted by the first side surface to form an exiting light having a propagation direction which is not parallel to a propagation direction of an exiting light refracted by the second side surface, so that the viewing angle diffusion plate has multiple modulation angles for a beam of incident light, enhancing the modulation ability of the viewing angle diffusion plate. When the display panel has a relatively concentrated light shape, the light shape of the modulated exiting light is more dispersed, which improves image quality of a display screen at a large viewing angle.

### BRIEF DESCRIPTION OF DRAWINGS

The technical solutions and other beneficial effects of the present application will be apparent through the detailed description of the specific implementation of the present application in conjunction with the accompanying drawings.

FIG. 1 is a schematic diagram of the first structure of a viewing angle diffusion plate in the present application;

FIG. 2 is a schematic diagram of a second structure of a viewing angle diffusion plate in the present application;

FIG. 3 is a schematic diagram of a third structure of the viewing angle diffusion plate in the present application;

FIG. 4 is the normalized brightness of the display panel at different viewing angles in the prior art and in the present application;

FIG. 5 is a schematic structural diagram of a display panel in an embodiment of the present application.

Elements in the drawings are designed by reference numerals listed below:
10. viewing angle diffusion plate; 11, substrate; 12, refractive protrusions; 121, first portion; 1211, first side surface; 122, second portion; 1221, second side surface; 13, protective layer; 14, polarizing film; 20, display screen body; 30, backlight module.

### DETAILED DESCRIPTION OF PREFERRED EMBODIMENTS

The following description of the various embodiments is provided to illustrate the specific embodiments of the invention. The spatially relative directional terms mentioned in the present invention, such as “upper”, “lower”, “before”, “after”, “left”, “right”, “inside”, “outside”, “side”, etc. and the like, may be used herein for ease of description to describe one element or feature's relationship to another element(s) or feature(s) as illustrated in the figures which are merely references. The spatially relative terms are intended to encompass different orientations in addition to the orientation as depicted in the figures.

The present application is directed to the technical problem that the existing viewing angle diffusion plate has a poor viewing angle diffusion effect when dealing with a display panel with a concentrated light shape emitted by a light source, which impacts customer experience.

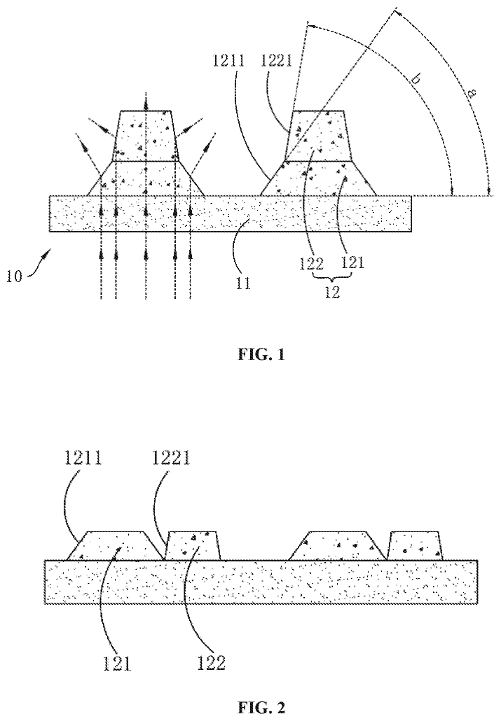

A viewing angle diffusion plate 10, as shown in FIG. 1, includes a substrate 11 and refractive protrusions 12 provided on a surface of the substrate 11; the substrate 11 and the refractive protrusions 12 are both made of transparent materials, the refraction protrusions 12 are configured to change a propagation direction of light incident into the viewing angle diffusion plate 10, and use light refraction to shift part of the light away from a central area of the viewing angle diffusion plate 10, thereby enhancing the brightness of a large viewing angle.

Specifically, each of the refractive protrusions 12 includes a first portion 121 and a second portion 122, the first portion 121 includes a first side surface 1211 forming a first angle a with the surface of the substrate 11, the second portion 122 includes a second side surface 1221 disposed close to the first side surface 1211 and forming a second angle b with the surface of the substrate 11, and the first angle a is greater than or less than the second angle b.

It should be noted that the first side surface 1211 of the first portion 121 of each of the refraction protrusions 122 is not parallel to the second side surface 1221 of the second portion 122. When a light beam emitted by the light source of the display panel is incident into the refraction protrusions 12, parallel light rays are refracted by the first side surface 1211 to form an exiting light having a propagation direction which is not parallel to a propagation direction of an exiting light refracted by the second side surface 1221, so that the viewing angle diffusion plate 10 has multiple modulation angles for a beam of incident light, enhancing the modulation ability of the viewing angle diffusion plate 10. When dealing with a display panel with a relatively concentrated light shape emitted by a light source, the light shape of the exiting light modulated by the viewing angle diffusion plate 10 is more dispersed, thereby improving the image quality of a large viewing angle display screen.

It should be noted that FIG. 1 only illustrates the case where each of the refractive protrusions 12 includes two portions. In actual implementation, each of the refractive protrusions may also include three, four, or more portions, and all portions on a same side are not parallel with each other, so that the viewing angle diffusion plate 10 has more modulation angles for the light beams with a concentrated light shape.

Specifically, the first side surface 1211 includes a first inclined surface inclined downward in a direction away from an axis of the first portion 121, and the second side surface 1221 includes a second inclined surface inclined downward in a direction away from an axis of the second portion 122. The first inclined surface is not parallel to the second inclined surface.

It should be noted that when the viewing angle diffusion plate 10 is attached to the display screen body, most of light is incident into the viewing angle diffusion plate 10 in a direction perpendicular to the surface of the substrate 11. By providing the first inclined surface and the second inclined surface, the light incident on the first inclined surface in the direction perpendicular to the surface of the substrate 11 is refracted by the first inclined surface and then shifted in a direction away from the first portion 121, and the light incident on the second inclined surface in the direction perpendicular to the surface of the substrate 11 is refracted by the second inclined surface and then shifted away from the second portion 122, such that the brightness at a large viewing angle is increased.

It should be noted that FIG. 1 only illustrates the case that all the sides of the first portion 121 may include the first side surface 1211, and all the sides of the second portion 122 may include the second side surface 1221. Alternatively, in actual implementation, a case may be that only opposite sides of the first portion 121 away from the central region of the viewing angle diffusion plate 10 include the first side surface 1211, and only opposite sides of the second portion 122 away from the central region of the viewing angle diffusion plate 10 include the second side surface 1221.

In one embodiment, each of an entire vertical cross section of the first portion 121 and an entire vertical cross section of the second portion 122 has a shape of positive trapezoid, so that part of the exiting light passing through the refraction protrusions 12 is shifted away from the central direction of the viewing angle diffusion plate 10, while part of the exiting light passing through the refraction protrusions 12 is shifted toward the center of the viewing angle diffusion plate 10. Meanwhile, part of the exiting light is emitted in a direction perpendicular to the surface of the substrate 11 to enhance the brightness of the large viewing angle while ensuring the frontal brightness of the display panel.

It should be noted that the entire vertical cross section of the first portion 121 may also have a shape a polygon, such as a triangle or a quadrangle, and the entire vertical cross section of the second portion 122 may also be have a shape a polygon, such as a triangle or a quadrangle.

Specifically, the entire the first portion 121 may has a shape of a circular truncated cone, a truncated cone, a trapezoidal truncated cone, or the like.

Specifically, a plurality of refraction protrusions 12 are provided. The plurality of refraction protrusions 12 can be evenly distributed on the surface of the substrate 11, and the plurality of refraction protrusions 12 can also be discretely distributed on the surface of the substrate 11.

In one embodiment, the plurality of refractive protrusions 12 are spaced apart from each other to ensure the display brightness when viewing the display panel frontally.

It should be noted that a distance between adjacent ones of the refractive protrusions 12 can be selected according to actual conditions. Generally, the denser the light source distribution of the display panel, the smaller the distance between adjacent ones of the refractive protrusions 12.

It should be noted that the shapes of the first portions 121 of all refractive protrusions 12 may be the same as or different from each other, and the shapes of the second portions 122 of all refractive protrusions 12 may be the same as or different from each other.

In one embodiment, the second portion 122 is located on a side of the first portion 121 away from the substrate 11.

In another embodiment, as shown in FIG. 2, the second portion 122 adjoins a side of the first portion 121.

Specifically, the first portion 121 may be integrally formed with the second portion 122, that is, the first portion 121 and the second portion 122 are formed of a same material by a same process. At this time, the refractive protrusions 12 may also be integrally formed with the substrate 11 to reduce the production process and cost.

It should be noted that the first portion 121 and the second portion 122 may also be formed of different materials, and a refractive index of the first portion 121 may be greater or less than a refractive index of the second portion 122, such that there are more modulation angles provided by the refractive projections 12.

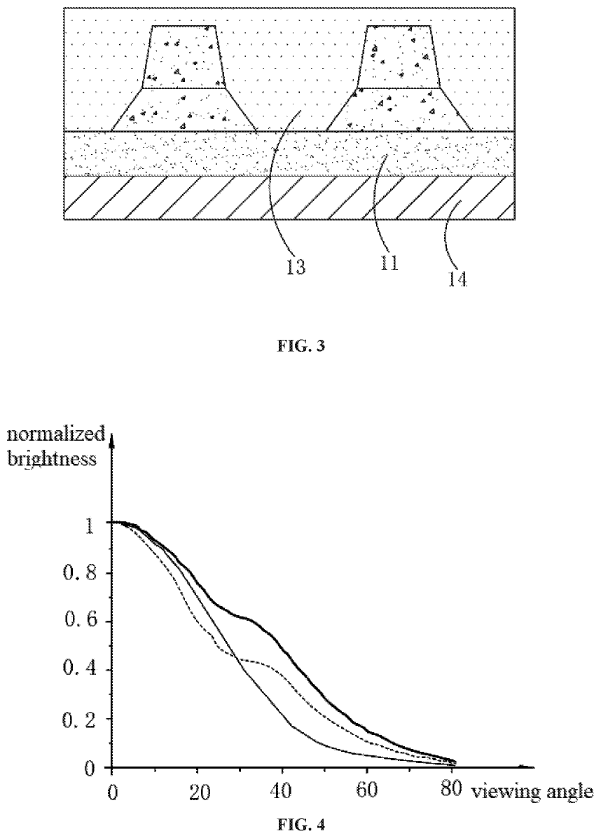

Specifically, as shown in FIG. 3, the viewing angle diffusion plate 10 further includes a protective layer 13 covering the refractive protrusions 12, and the protective layer 13 is made of a transparent material to protect the refractive protrusions 12.

A refractive index of the protective layer 13 is greater than a refractive index of the refractive protrusions 12, so that when the light enters the protective layer 13 from the first portion 121, the light is further deflected away from the first portion 121, and when the second portion 122 enters the protective layer 13 from the second portion 122, the light is further deflected away from the second portion 122, thereby improving the brightness of a larger viewing angle.

Specifically, the viewing angle diffusion plate 10 further includes a polarizing film 14 that is disposed on a side of the substrate 11 away from the refractive protrusions 12.

It should be noted that the combination of the refractive protrusions 12 and the polarizing film 14 allows the viewing angle diffusion plate 10 to serve as a large viewing angle polarizer, so that the viewing angle diffusion plate 10 can replace the polarizer on the existing display panel.

Referring to FIG. 4, FIG. 4 shows normalized brightness of the display panel in the prior art and the present application at different viewing angles.

The vertical coordinate corresponds to the normalized brightness, that is, the display brightness of the display panel at different viewing angles, the horizontal coordinate corresponds to the viewing angle, the thick solid line corresponds to the normalized brightness of the display panel using the viewing angle diffusion plate 10 in the present application at different viewing angles, the dotted line corresponds to the normalized brightness of the display panel with the viewing angle diffusion plate in the prior art at different viewing angles, and the thin solid line corresponds to the normalized brightness of the display panel without a viewing angle diffusion plate at different viewing angles. As shown FIG. 4, under the same light source, the display panel using the viewing angle diffusion plate 10 in the present application has better brightness at a large viewing angle.

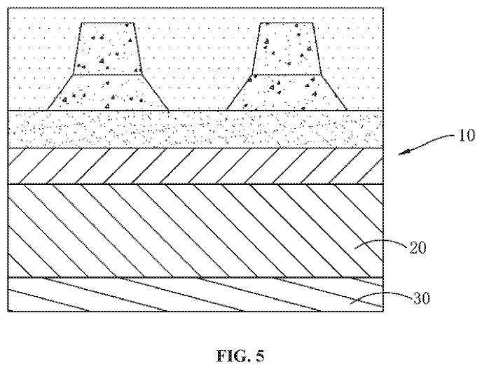

Based on the above-described polarizing film, the present application also provides a display panel. As shown in FIG. 5, the display panel includes a display screen body 20 and a viewing angle diffusion plate 10 as described in any of the above embodiments. The diffusion plate 10 is disposed on the light-exiting side of the display screen body 20.

Specifically, the display panel further includes a backlight module 30 disposed on a side of the display screen body 20 away from the viewing angle diffusion plate 10.

It should be noted that when the viewing angle diffusion plate 10 is attached to the display screen body 20, the viewing angle diffusion plate 10 has a light scattering effect. In this case, it is not necessary to add a scattering film to the backlight module 30, thereby reducing production costs.

The beneficial effects of the present invention are as follows: the first side surface 1211 of the first portion 121 of each of the refraction protrusions 12 is not parallel to the second side surface 1221 of the second portion 122. When a light beam emitted by the light source of the display panel is incident into the refraction protrusions 12, parallel light rays are refracted by the first side surface 1211 to form an exiting light having a propagation direction which is not parallel to a propagation direction of an exiting light refracted by the second side surface 1221, so that the viewing angle diffusion plate 10 has multiple modulation angles for a beam of incident light, enhancing the modulation ability of the viewing angle diffusion plate 10. When the display panel has a relatively concentrated light shape, the light shape of the modulated exiting light is more dispersed, which improves image quality of a display screen at a large viewing angle.

In the above embodiments, the descriptions of each embodiment have their own emphasis. The parts that are not described in detail in an embodiment can be referred to the detailed descriptions in other embodiments above, which will not be repeated herein for brevity.

Specific examples are used in this document to explain the principles and implementation of the present invention. The descriptions of the above embodiments are only for understanding the method of the present invention and its core ideas, to help understand the technical solution of the present application and its core ideas, and a person of ordinary skill in the art should understand that it can still modify the technical solution described in the foregoing embodiments, or equivalently replace some of the technical features. Such modifications or replacements do not depart the spirit of the corresponding technical solutions beyond the scope of the technical solutions of the embodiments of the present application.

What is claimed is:

1. A viewing angle diffusion plate, comprising a substrate and a plurality of refractive protrusions provided on a surface of the substrate,
wherein each of the refractive protrusions comprises a first portion and a second portion, the first portion comprises a first side surface forming a first angle with the surface of the substrate, and the second portion comprises a second side surface disposed close to the first side surface and forming a second angle with the surface of the substrate.

2. The viewing angle diffusion plate according to claim 1, wherein the first side surface comprises a first inclined surface inclined downward in a direction away from an axis of the first portion, and the second side surface comprises a second inclined surface inclined downward in a direction away from an axis of the second portion.

3. The viewing angle diffusion plate according to claim 2, wherein the second portion is located on a side of the first portion away from the substrate.

4. The viewing angle diffusion plate according to claim 2, wherein the second portion adjoins a side of the first portion.

5. The viewing angle diffusion plate according to claim 1, wherein a refractive index of the first portion is greater or smaller than a refractive index of the second portion.

6. The viewing angle diffusion plate according to claim 1, further comprising a protective layer covering the refractive protrusions, wherein a refractive index of the protective layer is greater than a refractive index of the refractive protrusions.

7. The viewing angle diffusion plate according to claim 1, further comprising a polarizing film disposed on a side of the substrate away from the refractive protrusions.

8. The viewing angle diffusion plate according to claim 1, wherein the plurality of the refractive protrusions are arranged at intervals.

9. The viewing angle diffusion plate according to claim 1, wherein the refractive protrusions are integrally formed with the substrate.

10. A display panel, comprising a display screen body and a viewing angle diffusion plate, wherein the viewing angle diffusion plate is disposed on a light-exiting side of the display screen body, and the viewing angle diffusion plate comprises a substrate and a plurality of refractive protrusions provided on a surface of the substrate,
wherein each of the refractive protrusions comprises a first portion and a second portion, the first portion comprises a first side surface forming a first angle with the surface of the substrate, the second portion comprises a second side surface disposed close to the first side surface and forming a second angle with the surface of the substrate.

11. The display panel according to claim 10, wherein the first side surface comprises a first inclined surface inclined downward in a direction away from an axis of the first portion, and the second side surface comprises a second inclined surface inclined downward in a direction away from an axis of the second portion.

12. The display panel according to claim 11, wherein the second portion is located on a side of the first portion away from the substrate.

13. The display panel according to claim 11, wherein the second portion adjoins a side of the first portion.

14. The display panel according to claim 10, wherein a refractive index of the first portion is greater or smaller than a refractive index of the second portion.

15. The display panel according to claim 10, further comprising a protective layer covering the refractive protrusions, wherein a refractive index of the protective layer is greater than a refractive index of the refractive protrusions.

16. The display panel according to claim 10, further comprising a polarizing film disposed on a side of the substrate away from the refractive protrusions.

17. The display panel according to claim 10, wherein the plurality of the refractive protrusions are arranged at intervals.

18. The display panel according to claim 10, wherein the refractive protrusions are integrally formed with the substrate.

19. The display panel according to claim 10, wherein each of an entire vertical cross section of the first portion and an entire vertical cross section of the second portion has a shape of positive trapezoid.

20. The display panel according to claim 10, wherein the first portion is integrally formed with the second portion.
